(19) United States
(12) Patent Application Publication
(10) Pub. No.: US 2003/0187834 A1
(43) Pub. Date: Oct. 2, 2003

(54) Document search method

(75) Inventors: Toshihiko Oda, Tokyo (JP); Hitoshi Hasegawa, Tokyo (JP); Kazuyuki Iida, Tokyo (JP); Hiroshi Hatakama, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/315,018

(22) Filed: Dec. 10, 2002

(30) Foreign Application Priority Data
Mar. 29, 2002 (JP) 2002-093713

(51) Int. Cl. G06F 17/30

(52) U.S. Cl. 707/3

(57) ABSTRACT

A document search method for extracting document information similar in content to given document information, from a document database with high accuracy and efficiency. A first document database is searched based on a search query which is input by a user. First document information extracted by the search of the first document database is formatted into a format of a second document database. The second document database is searched by using the formatted first document information. Second document information which is similar in content to the formatted first document information is extracted. A degree of similarity between the formatted first document information and the second document information is calculated. The calculated degree of similarity is corrected in accordance with a condition of correction which is preset. The first and second document information and the corrected degree of similarity are output.

### BACKGROUND OF THE INVENTION

1) Field of the Invention

The present invention relates to a document search method which is executed by a computer for extracting from a document database first document information which is similar to second document information acquired from a network. In particular, the present invention relates to a document search method which can increase accuracy in a degree of similarity between the first and second document information.

2) Description of the Related Art

Recently, the so-called business-model patent (business-method patent) has become a focus of attention, and companies are required to keep track of published business-model patents and patent applications. In particular, patents relating to businesses mechanisms which are actually used are important, and it is desired to become able to easily extract patents and patent applications relating to businesses mechanisms which are actually used. However, since the number of the business-model patent applications is rapidly increasing, it is becoming difficult for companies to extract necessary patent and patent applications. In this situation, for example, commercial services which extract an applicable business-model patent from among published business-model patents in accordance with a search query and make a timely report on the extracted business-model patent by using the Internet are currently available.

In addition, conventionally, a search technique called a similarity search or conceptual search is known as a technique which enables evaluation of a degree of similarity to a search condition. In a typical technique, a feature vector is calculated for each document based on words occurring in the document, and a degree of similarity is determined based on proximity between feature vectors. In addition, Japanese Unexamined Patent Publication No. 2001-331527 discloses a method in which a degree of similarity is determined based on correspondences between document structures when a document similar to another document designated as a search condition is extracted from documents to be searched, based on the contents of the designated document.

Further, a document search technique for extracting a similar document from a plurality of document databases is also known. For example, Japanese Unexamined Patent Publication No. 2000-155758 discloses a method in which a document search is efficiently made for investigating relationships between a plurality of document databases, for example, for viewing articles in an encyclopedia relating to a newspaper article which a user is interested in. In this method, words which frequently appear in a newspaper article are extracted as an abstract of the document, and an encyclopedia is searched by using the abstract. Furthermore, Japanese Unexamined Patent Publication No. 10-031677 discloses a method for searching a plurality of document databases for document data items which are similar in their meaning by using a plurality of word dictionaries in the case where the plurality of document databases are described in different languages.

Although some of the aforementioned commercial services making a timely report on the extracted business-model patent also provide an evaluation (e.g., a degree of importance) of the extracted patent information, such services will be further useful for companies if it is possible to evaluate a degree of similarity between the extracted business-model patent and a business which is actually carried out. However, conventionally, in order to make such an evaluation, a person which has profound knowledge in the field to which the extracted business-model patent and the business which is actually carried out belong is necessary. Therefore, it is desired to efficiently perform the above services without human assistance.

Since business-model patent applications often relate to an entire business mechanism or a core business mechanism, a number of business-model patent applications can be extracted associated with announcements of new businesses. For example, documents indicating details of businesses corresponding to patent applications often exist on internet sites, where the documents are, for example, press releases by companies as the applicants of the patent applications or articles for introducing services. Specifically, documents corresponding to business-model patents often exist in press releases or pages introducing business details in official web sites of the applicants (companies) or related companies of the applicants, articles informing of new services in web sites of the applicants, news articles or newspaper articles delivered as charged services or the like, and other places in web sites. Therefore, it is desired to efficiently extract published business-model patents and patent applications associated with documents existing on the Internet or other databases.

In addition, in order to evaluate a degree of similarity to a document extracted by a search of a plurality of databases as above, the aforementioned conventional similarity search technique can be used. However, in the conventional similarity search, a degree of similarity is determined by simply correlating only document structures in two databases. Therefore, the conventional similarity search is insufficient for making an evaluation with high accuracy. Thus, it is desired to accurately and efficiently extract a document and evaluate a degree of similarity, by making an analysis based on information specific to a target field of the search as well as a conventional similarity search.

Further, in a situation in which a company is carrying out a business in competition with another company, it is necessary to watch whether or not the competitor company has filed a business-model patent application corresponding to the business. However, currently, human assistance is necessary for monitoring patent applications. Therefore, a system which extracts the corresponding business-model patent with high efficiency and accuracy and enables notification at the time of publication of the business-model patent is desired.

### SUMMARY OF THE INVENTION

The present invention is made in view of the above problems, and the object of the present invention is to provide a document search method enabling extraction of document information which is similar in content to given document information, from a document database with high efficiency and accuracy.

In order to accomplish the above object, a document search method to be executed by a computer for extracting from a document database document information similar to other document information which is acquired from a network is provided. The document search method is characterized in that the computer formats first document information acquired from the network into a format of the document database, and outputs second document information and similarity information, where the second document information exists in the document database and is similar to the formatted first document information, and the similarity information is obtained by correcting a degree of similarity between the formatted first document information and the second document information in accordance with a condition which is preset.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

In the drawings:

FIG. 1 is a diagram provided for explaining the principle of the present invention;

FIG. 2 is a diagram illustrating an example of a construction of a system as an embodiment of the present invention;

FIG. 3 is a diagram illustrating a hardware construction of a document-search server used in the embodiment of the present invention;

FIG. 4 is a block diagram illustrating functions of the document-search server;

FIG. 5 is a flowchart of a sequence of processing in a network-document-search processing unit;

FIG. 6 is a diagram illustrating an example of information held by an investment-relationship database;

FIG. 7 is a diagram illustrating an example of information held by a company-domain correspondence database;

FIG. 8 is a flowchart of a sequence of similarity correction processing using the investment-relationship database and the company-domain correspondence database;

FIG. 9 is a diagram illustrating an example of display of a screen for notifying a terminal user about a search result;

FIG. 10 is a diagram illustrating an example of information preliminarily registered in the document-search server;

FIG. 11 is a diagram illustrating an example of display of a document attached to an email transmitted to a registrant;

FIG. 12 is a block diagram illustrating functions of a delivery server;

FIG. 13 is a diagram illustrating an example of display of a screen for requesting transmission of information on a patent;

FIG. 14 is a flowchart of a sequence of processing in a search-result processing unit; and

FIG. 15 is a diagram illustrating an example of display of a document attached to an email to a user.

### DESCRIPTION OF THE PREFERRED EMBODIMENTS

Embodiments of the present invention are explained below with reference to drawings.

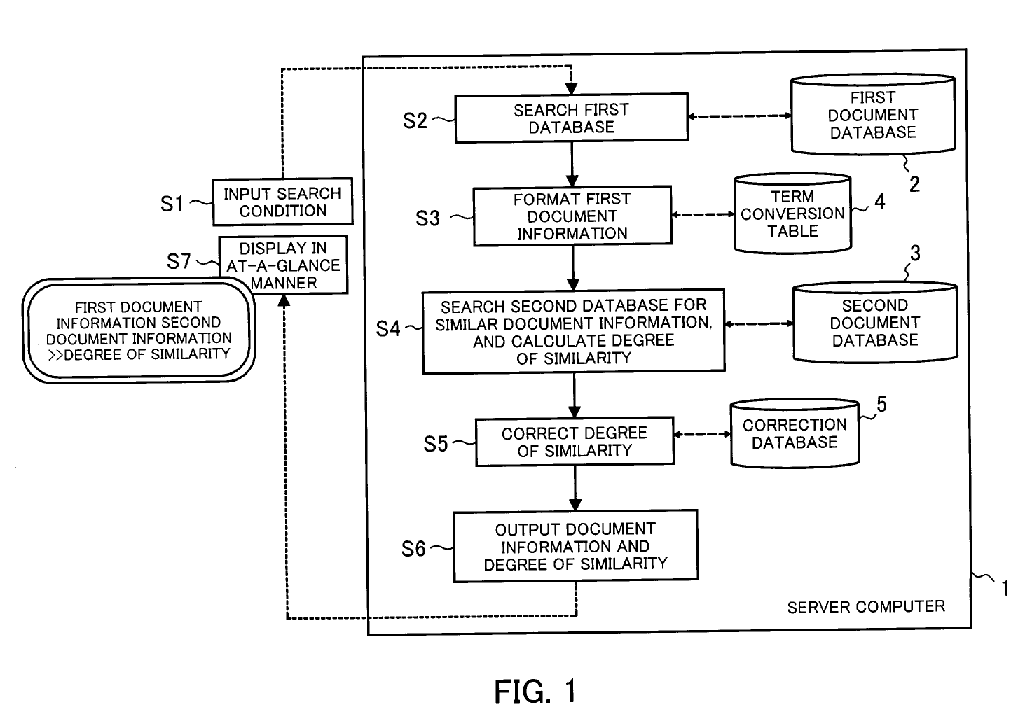

FIG. 1 is a diagram provided for explaining the principle of the present invention.

The present invention makes a computer execute processing for searching a document database for first document information which is similar in content to second document information, and outputting the first document information obtained by the search and a degree of similarity between the first and second document information. The second document information as the search reference is acquired, for example, through a network. Alternatively, the second document information as the search reference may be document information extracted from another document database. In addition, the document database from which the second document information is extracted may be provided on a network. In this case, the second document information may be received through the network. On the other hand, the searched document database may also be provided on a network. Alternatively, the searched document database may be included in the above computer.

The following explanations with reference to FIG. 1 are provided for an example case where the present invention is applied to a server computer 1 which provides a web site on the Internet, and realizes a service which provides a processing result to a user of a terminal. In this example, the server computer 1 receives a search query from the user through the Internet, and searches a first document database 2 based on the search query. At this time, first document information obtained by the search is used as the aforementioned search reference, and second document information which is similar in content to the first document information is obtained by search of a second document database 3.

In this service, the server computer 1 searches the first document database 2 and the second document database 3 in accordance with a certain search condition which is input, and sends to the user the document information having the similar contents and a degree of similarity between the first and second document information. At this time, different types of document information are stored in advance in the first document database 2 and the second document database 3, respectively. For example, document information on unexamined patent publications acquired from a database of a patent office is stored in the first document database 2, and document information on articles published on companies' sites on the Internet, document information delivered as news articles, and the like are collected and stored in the second document database 3.

The first document database 2 and the second document database 3 may be included in the server computer 1, or in a database server computer which is connected through a network such as the Internet.

Next, processing for service provision is explained step by step. This processing is started when a user of a terminal accesses the web site provided by the server computer 1 through the Internet. At this time, for example, an input screen for a search condition is displayed on the terminal.

In step S1, the user inputs a search condition, and a search query is transmitted to the server computer 1. In step S2, the server computer 1 searches the first document database 2 based on the search query. At this time, the search condition includes an arbitrary word or phrase based on which document information in the first document database 2 is searched for, a publication date of the document information, a company name in the document information, and the like. When a tag is affixed to, for example, each item in the document information in the first document database 2 in accordance with XML (eXtensible Markup Language) or the like, it is possible to designate the tag as a target of the search.

As a result of the search of the first document database 2, the server computer 1 outputs first document information. In step S3, the first document information obtained by the search is formatted so as to be adapted for the search of the second document database 3. The formatting processing is preprocessing which is performed for an accurate and efficient search of the second document database 3 (in which a different type of document information is stored) before extraction of document information which is similar in content to the first document information by a search of the second document database 3 in step S4.

In the formatting processing, descriptions in a specific portion of the first document information which portion is not examined in the search of the second document database 3 is removed from the first document information. For example, in the case of a patent publication, the contents of the document information are divided into items such as “claims” and “applicant.” Therefore, in this case, the portion to be removed is designated in advance on an item-by-item basis. In addition, when the above items are defined with XML tags or the like, the portion to be removed may be designated by the tags.

In another technique of the formatting processing, a term conversion table 4 in which terms in the first document database 2 are related to terms in the second document database 3 is provided, and the terms in the first document database 2 are converted based on the term conversion table 4. Further, it is possible to accurately and efficiently search the second document database 3 by using the term conversion table 4 in combination with the removal of a portion of the first document information which is not examined in the search of the second document database 3.

In step S4, processing for searching the second document database 3 for second document information which is similar in content to the formatted first document information is performed. In addition, based on the search result, a degree of similarity between the formatted first document information and the second document information extracted by the search is calculated. The degree of similarity is calculated by the conventionally used technique of the similarity search, which is based on correspondences between document structures in the respective databases. For example, the degree of similarity is obtained by cutting out words from each of the formatted first document information and the extracted second document information, obtaining two frequency vectors constituted by frequencies of each word in the formatted first document information and the extracted second document information, and calculating the cosine value of the angle between the two frequency vectors.

In step S5, the calculated degree of similarity is corrected in accordance with a condition of correction, which is preset. At this time, the accuracy of the degree of similarity is increased by correcting the degree of similarity in consideration of information specific to the field of the document information obtained by the searches or the like.

For example, correction of the degree of similarity in accordance with the following three conditions of correction can be considered.

The first condition of correction is that both of time information included in the first document information searched for and time information included in the second document information searched for are within a predetermined time period. When the first condition of correction is satisfied, the degree of similarity is increased. For example, in the case where unexamined patent publications are stored in the first document database 2, the above time information can be a filing date of each patent application. In this case, when an article published near the filing date is obtained by the search of the second document database 3, the degree of similarity is increased.

The second condition of correction is that a word or phrase relating to a specific word or phrase included in the first document information is included in the second document information. When the second condition of correction is satisfied, the degree of similarity is increased. For example, it is possible to store in advance a specific word or phrase and a word or phrase relating to the specific word or phrase are stored in advance in a correction database 5, and make a correction with reference to the correction database 5.

For example, in the case where unexamined patent publications are stored in the first document database 2, the above specific word or phrase may be a description of an applicant included in the first document information. In many cases, a name of a company is written in the item of the applicant. On the other hand, when document information on web sites is stored in the second document database 3, the above word or phrase relating to the specific word or phrase may be a URL (Uniform Resource Locator) of a web site related to the company, a name of another company which has an investment relationship with the above company as the applicant, or the like. In this case, correction becomes possible when a company database is provided as the correction database 5, and indicates correspondence between the name of the above company as the applicant and the URL or domain name of the web site or the name of the other company which has an investment relationship with the company as the applicant. The web site related to the company as the applicant may include, for example, a page introducing the company, a page of a service provided by the company, or the like.

When the correspondence between the name of the company as the applicant and the URL is considered in the above correction using the correction database 5, it is possible to definitely determine that the first document information and the second document information obtained by the searches are highly related to each other. In addition, when the correspondence between the name of the company as the applicant and the company which has an investment relationship with the above company as the applicant is considered in the above correction using the correction database 5, it is possible to extract the related document information with higher reliability without overlooking relevance of document information which cannot be determined based on only the name of the company as the applicant.

The third condition of correction is that a specific word or phrase which indicates a correspondence to the first document information is included in the second document information. When the third condition of correction is satisfied, the degree of similarity is increased. For example, in the case where unexamined patent publications are stored in the first document database 2, the above specific word or phrase can be a word or phrase which indicates that a patent application relating to the contents of the second document information is currently pending. Thus, when the first document information corresponding to the second document information is obtained by the search, the degree of similarity is increased.

As explained above, the degree of similarity is calculated based on correspondence between only document structures of the formatted first document information and the second document information in step S4, and an analysis using information specific to the field of the document information, such as a filing date of a patent application or a publication date of the document information obtained by the search, in step S5. Therefore, document information can be more efficiently correlated, and therefore the accuracy of the degree of similarity can be improved.

In addition, when a portion or an item of the document information to be examined in accordance with the condition of correction is indicated by an XML tag or the like, it is possible to universally realize the aforementioned correction processing. For example, when items of a documentation date, a registration time, a filing date of a patent application and the like for the first condition of correction is indicated by tagging in document information in each document database, it is possible to define in advance the items to be examined with respect to time information, and efficiently perform the correction processing.

In step S6, the first document information and the second document information obtained by the searches are output together with the degree of similarity corrected in step S5. Then, in step S7, the output data is displayed by the terminal of the user so as to be read at a glance.

In practice, in the search processing in step S2, often, a plurality of documents (hereinbelow referred to as first documents) are extracted as the first document information from the first document database 2. Therefore, the processing in steps S3 to S5 is repeated for the respective first documents, or performed in parallel on the respective first documents. In addition, in the search processing in step S4, often, a plurality of documents (hereinbelow referred to as second documents) similar to one of the first documents are extracted from the second document database 3. In this case, the degree of similarity is calculated and corrected in step S5 for each of the second documents. Thus, in the case where a plurality of first documents are extracted from the first document database 2, and a plurality of second documents similar to each of the first documents are extracted from the second document database 3, the plurality of items of the first document information are displayed, and the plurality of second documents similar to each of the first documents and a plurality of degrees of similarity are displayed, in step S7. At this time, the plurality of second documents similar to each of the plurality of first documents may be displayed in order of decreasing similarity.

When the first and second document information and the degree of similarity between the first and second document information are output after the processing in steps S2 to S5, it is possible to construct a workflow in which the data of the first and second document information and the degree of similarity are sent to, for example, a person who evaluates the degree of similarity or is interested in the data, by using a so-called push-type notification means such as email or instant messaging in accordance with a condition designated in advance.

In the above workflow, for example, when the person who evaluates the degree of similarity receives the above data, the person evaluates the first and second document information and the degree of similarity based on knowledge which the person has, and returns an evaluation result. In addition, when the person who is interested in the data receives the above data, the person returns information indicating whether or not the received data affects a business of the person, or other information. The evaluation result or the information on the effect on the business, which is returned as above, is attached to the data output to the user in step S6, for example, as a comment.

The operations in the above workflow may be performed for each document extracted in the processing in steps S2 to S5, or for each user, or at predetermined time intervals.

In the above processing for service provision, the first document information and the second document information having similar contents are respectively obtained by the searches of the first document database 2 and the second document database 3 of different types based on a search query, and a degree of similarity between the first and second document information is output. Since the degree of similarity is corrected according to information specific to the field of the document information stored in each document database by the correction processing in step S5, the degree of similarity output as above becomes a value which more effectively reflects the actual situation. Therefore, it is possible to extract from the second document database 3 the second document information which is similar in content to the first document information extracted from the first document database 2, with high accuracy and efficiency.

When the present invention is used, various document-search services can be provided by a web server. For example, it is possible to easily realize a web server which provides published patent information on a business-model patent and a document existing on the Internet and relating to an actual business corresponding to the business-model patent.

Hereinbelow, an embodiment of the present invention is explained in detail. In the embodiment, the present invention is applied to a web server which provides a service for searching a document relating to a business-model patent.

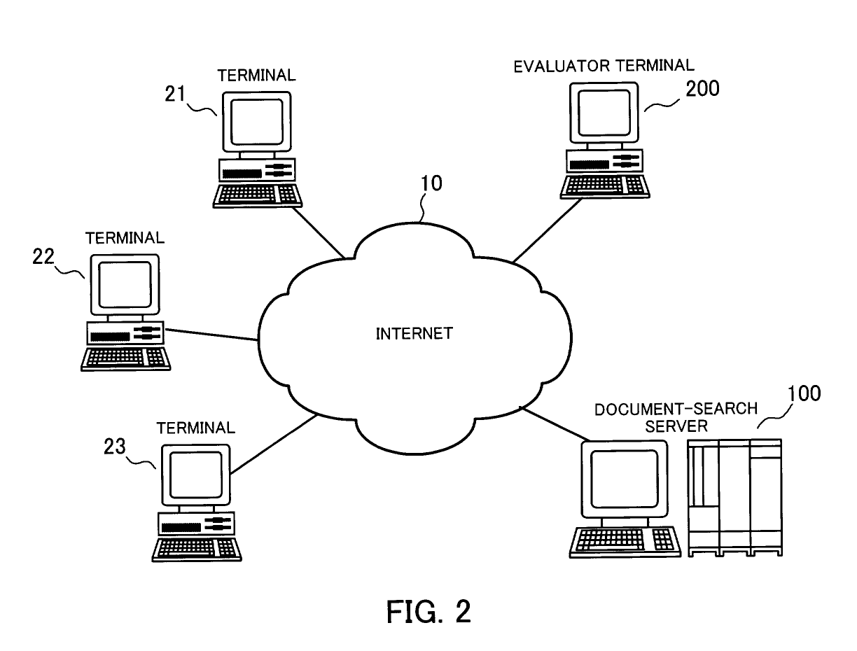

FIG. 2 is a diagram illustrating an example of a construction of a system as the embodiment of the present invention.

In the present embodiment, a plurality of terminals 21, 22, and 23, a document-search server 100, and an evaluator terminal 200 are connected through the Internet 10.

The plurality of terminals 21, 22, and 23 are each a terminal used by a user and realized by, for example, a personal computer. The document-search server 100 is a web server which provides a document-search service relating to a business-model patent to the plurality of terminals 21, 22, and 23. The evaluator terminal 200 is a terminal which is used by a person who can evaluate a result of processing by the document-search server 100. The evaluator terminal 200 carries out communication such as transmission and reception of emails to and from the document-search server 100.

In addition, the system of FIG. 2 may also be connected to a patent office server which provides various publications from a patent office through the Internet 10. Further, the system of FIG. 2 may be further connected to database servers which provide various database services, news delivery servers which deliver news articles, and the like.

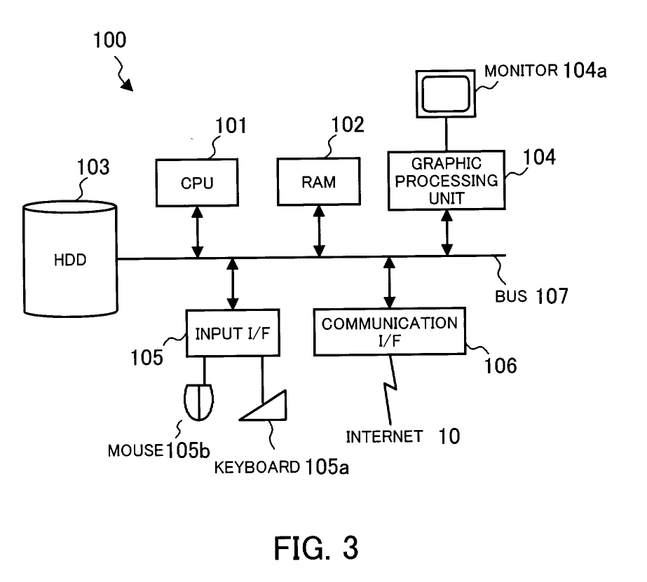

FIG. 3 is a diagram illustrating a hardware construction of the document-search server 100 used in the embodiment of the present invention.

As illustrated in FIG. 3, the document-search server 100 comprises a CPU (Central Processing Unit) 101, a RAM (Random Access Memory) 102, an HDD (Hard Disk Drive) 103, a graphic processing unit 104, an input I/F (interface) 105, and a communication I/F (interface) 106. These elements are interconnected through a bus 107.

The CPU 101 controls the entire document-search server 100. The RAM 102 temporarily stores at least a portion of a program which is executed by the CPU 101, and various data which are necessary for processing in accordance with the program. The HDD 103 stores an OS (operating system), application programs, and various data.

A monitor 104a is connected to the graphic processing unit 104. The graphic processing unit 104 makes the monitor 104a display an image in accordance with an instruction from the CPU 101. A keyboard 105a and a mouse 105b are connected to the input I/F 105. The input I/F 105 transmits signals from the keyboard 105a and the mouse 105b to the CPU 101 through the bus 107. The communication I/F 106 is connected to the Internet 10, and transmits and receives data to and from another computer through the Internet 10.

Processing functions of the present embodiment can be realized by using the above hardware construction. Although FIG. 3 illustrates an example of a hardware construction of the document-search server 100, the plurality of terminals 21, 22, and 23 and the evaluator terminal 200 can also be realized by using similar hardware constructions, respectively.

Next, the processing functions of the document-search server 100 are explained below.

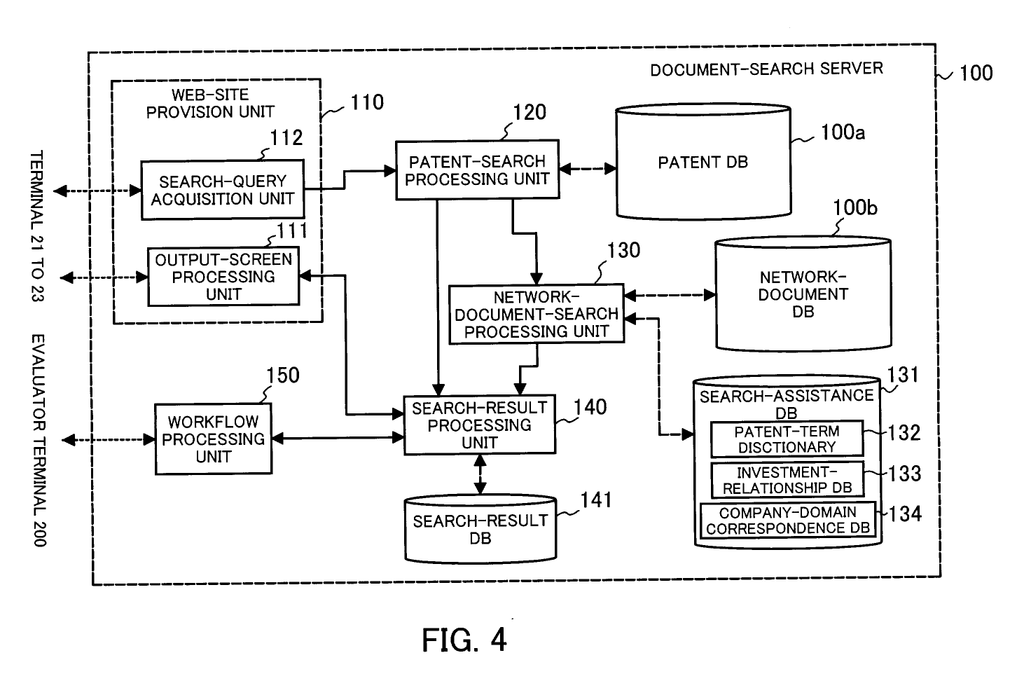

FIG. 4 is a block diagram illustrating functions of the document-search server 100.

As illustrated in FIG. 4, the document-search server 100 comprises a web-site provision unit 110, a patent-search processing unit 120, a network-document-search processing unit 130, a search-result processing unit 140, and a workflow processing unit 150. The web-site provision unit 110 performs processing for providing information in a web site to the plurality of terminals 21, 22, and 23 when the plurality of terminals 21, 22, and 23 access the web site. The patent-search processing unit 120 performs processing for searching a patent database 100a. Hereinafter, a database is referred to as a DB. The network-document-search processing unit 130 performs processing for searching a network-document DB 100b. The search-result processing unit 140 performs output processing or the like on a search result. The workflow processing unit 150 executes a workflow associated with the output of the search result. In addition, the document-search server 100 also comprises a search-assistance DB 131 and a search-result DB 141. The search-assistance DB 131 assists the network-document-search processing unit 130 in processing, and the search-result DB 141 holds the search result.

The web-site provision unit 110 comprises an output-screen processing unit 111 and a search-query acquisition unit 112. The output-screen processing unit 111 performs processing for outputting various webpage screens in the document-search service to the plurality of terminals 21, 22, and 23, e.g., outputting a screen for input of a search condition or the like. In addition, when the output-screen processing unit 111 receives a search result from the search-result processing unit 140, the output-screen processing unit 111 incorporates the search result into a webpage screen, and outputs the webpage screen. The search-query acquisition unit 112 acquires from each of the plurality of terminals 21, 22, and 23 a search condition which is input into the screen for input of the search condition, and outputs the search condition to the patent-search processing unit 120.

The patent-search processing unit 120 searches the patent DB 100a by using the search condition received from the search-query acquisition unit 112, extracts a corresponding document, and outputs the document to the network-document-search processing unit 130 and the search-result processing unit 140. At this time, the patent DB 100a mainly stores documents (e.g., unexamined patent publications) published by a database server in a patent office. For example, these documents are regularly collected from the database server in the patent office and stored in the patent DB 100a. These documents are XML tagged for each item such as “title of the invention” or “applicant.”

The patent DB 100a can store various patent documents including patent specifications as well as the unexamined patent publications. However, in this embodiment, for simplicity of explanation, it is assumed that the patent DB 100a stores only the unexamined patent publications. Alternatively, it is possible to not to have the patent DB 100a and access the database server in the patent office for acquiring an applicable document every time a search condition is input.

The network-document-search processing unit 130 refers to the search-assistance DB 131 when necessary, and searches the network-document DB 100b for a document having contents similar to the contents of the document obtained by the patent-search processing unit 120. In addition, the network-document-search processing unit 130 calculates a degree of similarity between the corresponding documents, and outputs the calculated degree of similarity to the search-result processing unit 140. Although the search-assistance DB 131 stores a patent-term dictionary 132, an investment-relationship DB 133, and a company-domain correspondence DB 134, these elements are explained later.

The network-document DB 100b stores various documents existing in web sites on the Internet 10, where the web sites include a web site of a company, a web site which provides a service, a web site which delivers news articles, and other web sites. For example, these documents are obtained by regularly acquiring documents in designated web sites or acquiring from other databases, and stored one by one in the network-document DB 100b, where the other databases may include external network-search databases which collect documents on the Internet 10 by using a robot, databases of newspaper articles or news articles, press-release databases, and other commercial databases.

The above documents are XML tagged for bibliographic information items or the like, where the bibliographic information items may include dates and times of publication, names of companies which publish the documents, and URLs. Alternatively, the above documents may be tagged in accordance with News ML (News Markup Language), DublinCore, or the like.

The search-result processing unit 140 stores in the search-result DB 141 documents obtained by searches of the patent DB 100a and the network-document DB 100b and a degree of similarity between the documents, and outputs results of the searches to the workflow processing unit 150 and the output-screen processing unit 111 in the web-site provision unit 110. In addition, the search-result processing unit 140 updates data stored in the search-result DB 141 and data to be output to the output-screen processing unit 111 according to information received from the workflow processing unit 150.

The workflow processing unit 150 executes a predetermined workflow according to the results of the searches received from the search-result processing unit 140. When the workflow processing unit 150 receives a result of the workflow execution, the workflow processing unit 150 outputs the result to the search-result processing unit 140. For example, the workflow processing unit 150 sends the results of the searches received from the search-result processing unit 140 to the evaluator terminal 200 by email or instant mail, and outputs to the search-result processing unit 140 information returned in response to the results of the searches.

Incidentally, business-model patent applications are often deeply related to actual businesses. For example, in many cases, when a business-model patent application is filed, an announcement article about a business corresponding to the business-model patent application is published on a web site of a company, or a news article about the business is delivered. Therefore, it is likely that a document about an actual business corresponding to a filed business-model patent application exists on the Internet 10.

The document-search server 100 stores unexamined patent publications in the patent DB 100a and various documents published on the Internet 10 in the network-document DB 100b, and provides a service in which, in response to a request from a company or the like, the patent DB 100a is searched for an unexamined patent publication, the network-document DB 100b is searched for a document on the Internet 10 corresponding to the unexamined patent publication, and the unexamined patent publication and the corresponding document are supplied to the company or the like. In addition to the supply of the unexamined patent publication and the corresponding document, the document-search server 100 calculates and provides a degree of similarity of each document. Since the degree of similarity is calculated and supplied together with the corresponding documents as above, the service provided by the document-search server 100 is useful to the company which receives the search results.

Hereinbelow, processing for providing the above service is explained step by step.

First, when a search condition is input through the search-query acquisition unit 112, the patent-search processing unit 120 searches the patent DB 100a by using the search condition. At this time, the input search condition is mainly a condition for searching for an unexamined patent publication stored in the patent DB 100a. For example, it is possible to designate an arbitrary word or phrase for each of the items of “title of the invention,” “applicant,” “claims,” “field of the invention,” and the like. In addition, it is possible to make a search by designating a range of time information such as “filing date” or “publication date.”

For example, when the search condition specifies that the IPC (International Patent Classification) is “G06F17/60,” and the publication date belongs to the previous month, the patent-search processing unit 120 searches the patent DB 100a based on the search condition. An unexamined patent publication obtained by the search is output to the network-document-search processing unit 130, and information on a patent publication number, a title of the invention, an applicant, and the like of the unexamined patent publication or the entire unexamined patent publication is output as a result of the search of the patent DB 100a to the network-document-search processing unit 130.

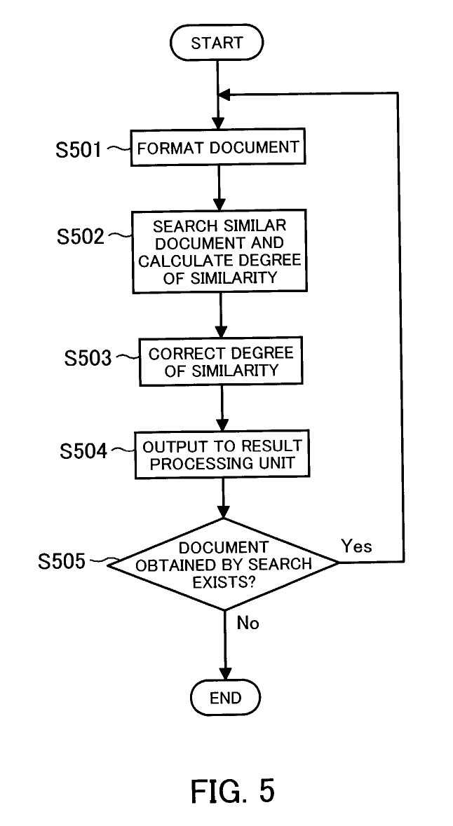

Next, processing performed by the network-document-search processing unit 130 is explained below. FIG. 5 is a flowchart of a sequence of the processing in the network-document-search processing unit 130.

In step S501, a document (unexamined patent publication) output from the patent-search processing unit 120 is formatted so as to be adapted for a search of the network-document DB 100b in step S502.

In step S502, the network-document DB 100b is searched for a document having contents similar to the contents of the formatted document, and a degree of similarity between the documents is calculated. In step S503, the calculated degree of similarity is corrected so as to increase the accuracy of the degree of similarity. In this processing, the investment-relationship DB 133 or the company-domain correspondence DB 134 in the search-assistance DB 131 is referred to when necessary. In step S504, the document output from the network-document DB 100b and the degree of similarity corrected in step S503 are output to the search-result processing unit 140.

In step S505, it is determined whether or not any other document is received from the patent-search processing unit 120. When yes is determined in step S505, the operation goes back to step S501, and the processing in steps S501 to S504 is repeated for all the other received document or documents. When no is determined in step S505, the sequence of FIG. 5 is completed.

Details of the processing in each of the above steps are explained below.

The formatting processing in step S501 includes the following two types of processing.

In the first type of processing, portions of the document output from the patent-search processing unit 120 in which a style or phrase unique to the patent specification is used are removed. Specifically, descriptions in the items “claims” and “means for solving the problem” are removed. These items can be easily removed when these items are indicated by XML tagging.

In the second type of processing, terms in the document output from the patent-search processing unit 120 which are used in only patent specifications are converted into general words used in the documents in the network-document DB 100b. For example, the expressions “automatic transaction apparatus” and “image formation apparatus” can be replaced with “ATM (Automatic Teller Machine)” and “copier/printer,” respectively. It is preferable to store in advance a list of corresponding terms in the patent-term dictionary 132, which is provided in the search-assistance DB 131. In the above processing, it is preferable that words in each document obtained by the search are searched, and terms listed in the patent-term dictionary 132 be replaced with corresponding terms in the patent-term dictionary 132.

Thus, in the formatting processing in step S501, the style, terms, and the like in the document obtained by the search of the patent DB 100a are brought closer to those in the documents stored in the network-document DB 100b, so that the network-document DB 100b can be searched in step S502 with high accuracy and efficiency.

In step S502, the network-document DB 100b is searched for a document having contents similar to the contents of the formatted document, and a degree of similarity is calculated. In the processing in step S502, the network-document DB 100b is searched for a document relating to a business corresponding to the unexamined patent publication obtained by the search of the patent DB 100a.

In the conventional search processing, a search range is narrowed based on information on the applicant of the unexamined patent publication which is obtained by the search of the patent DB 100a, and thereafter processing for extracting a similar document based on the document structure is performed. However, the business corresponding to a business-model patent is not necessarily published or conducted by the company as the applicant. Therefore, in step S502, the search is made based on only the document structures so that documents are extracted from a wide range which is not limited by the name of the company without omission. Then, in step S503, the degree of similarity is corrected by using the name of the company as the applicant.

In a special case where an unexamined patent publication obtained by the search of the patent DB 100a includes an indication of “exception to loss of novelty,” a document as an object of the “exception to loss of novelty” is extracted in advance by a search of the network-document DB 100b.

The search of the document having similar contents and the calculation of the degree of similarity are made in the following manners.

First, a morphemic analysis, which cuts out words from a document, is performed on each of the search reference document (unexamined patent publication) and the document in the network-document DB 100b. Then, a word-frequency vector in each document is obtained, and a cosine value of an angle between the two frequency vectors is calculated as a degree of similarity. That is, the cosine value of the angle between the two frequency vectors (i.e., degree of similarity) is obtained by the following equation (1).

$$\begin{matrix}cos θ = \frac{X \cdot Y}{\vert X \vert \cdot \vert Y \vert} \\ = \frac{\sum {x}_{i} \cdot {y}_{i}}{{( \sum {x}_{i}^{2} )}^{1 / 2} \cdot {( \sum {y}_{i}^{2} )}^{1 / 2}} ,\end{matrix} \qquad ( 1 )$$

where (x·y) is an inner product of x and y, |x| and |y| are respectively absolute values of the vectors x and y, xᵢ is the number of occurrences of an i-th word included in a document X extracted by a search of the patent DB 100a, and yᵢ is the number of occurrences of a word identical to the i-th word included in a document Y which is extracted by a search of the network-document DB 100b.

In the above document search, a characteristic word may be extracted from each document, and a weight may be assigned to each characteristic word. In addition, when a plurality of documents are obtained by a search of the network-document DB 100b corresponding to an unexamined patent publication, only documents having degrees of similarity equal to or greater than a predetermined value may be forwarded to a subsequent processing step.

Further, when a document written in a language different from the document extracted by the search of the patent DB 100a is searched for in the processing in step S502, the search and calculation of a degree of similarity are enabled by making provisions for the difference in the language in only the morphemic analysis processing.

Next, in step S503, the calculated degree of similarity is corrected. At this time, the correction is made based on information indicating correspondence between the documents obtained by searches. Specifically, the following three types of information are used for the correction.

The first type of information is information on date and time in each document. Specifically, information on the “filing date” and information on the “publication date and time” are extracted from each unexamined patent publication and each document in the network-document DB 100b, respectively, by designating the information by XML tags. Then, the degree of similarity is increased when the publication date and time is near the filing date. For example, the degree of similarity is increased by 3% for a document which is published within three months of the filing date. This is because many business-model patent applications are filed immediately before corresponding businesses are announced or corresponding services are started, and relevance between a patent application document and a document in the network-document DB 100b is great when the filing date is near the publication date.

The second type of information is descriptions specific to documents in the field of patent applications. For example, many documents for announcement of a business corresponding to a filed patent application include a description such as “patent pending.” When a document extracted by the search of the network-document DB 100b includes such a description, it is apparent that a corresponding patent specification is stored in the patent DB 100a. Therefore, when such a description is found by scanning of a document obtained by a search of the network-document DB 100b, the degree of similarity is increased by, for example, 5%.

The third type of information is information related to company names indicated as the “applicant” in unexamined patent publications. For example, when a URL in a web page indicated in a document extracted by the search of the network-document DB 100b or a name of a company or service in the document is related to a name of a company indicated as the “applicant,” the degree of similarity is increased.

However, the company indicated as the “applicant” does not necessarily conduct the business. Therefore, the investment-relationship DB 133, which indicates correspondences between invested companies and investor companies, is provided so that companies relating to the applicant company can be extracted without omission. Further, in order to check the relevance between companies and URLs in documents, the company-domain correspondence DB 134, which indicates correspondences between company names and domains in URLs, is provided.

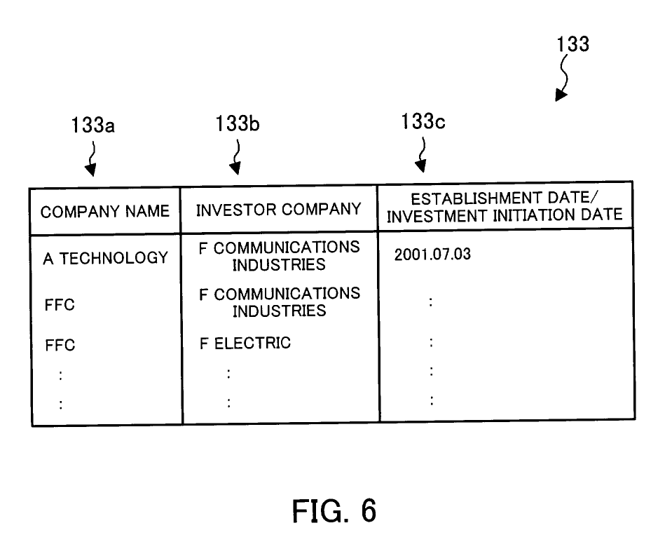

FIG. 6 is a diagram illustrating an example of information held by the investment-relationship DB 133.

As illustrated in FIG. 6, in the investment-relationship DB 133, names of companies 133a, investor companies 133b which invest in the respective companies and establishment dates or investment initiation dates 133c of the respective companies are indicated in the investment-relationship DB 133. It is possible to extract a company or companies which invest an applicant company, by referring to the investment-relationship DB 133. In addition, since the establishment dates or investment initiation dates 133c are held in the investment-relationship DB 133, it is possible to dispense with extraction of a company or companies which have built a relationship before the publication date, and increase the efficiency of the processing.

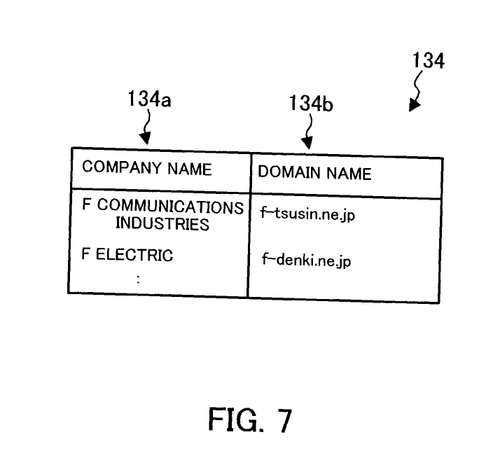

FIG. 7 is a diagram illustrating an example of information held by the company-domain correspondence DB 134.

As illustrated in FIG. 7, correspondences between company names 134a and domain names 134b are indicated in the company-domain correspondence DB 134. It is possible to determine whether or not a document extracted by a search of the network-document DB 100b belongs to an official web site of a target company or a web site in which the target company provides a service, by extracting a domain name from the company-domain correspondence DB 134, and comparing the domain name with a URL of the document extracted by the search of the network-document DB 100b.

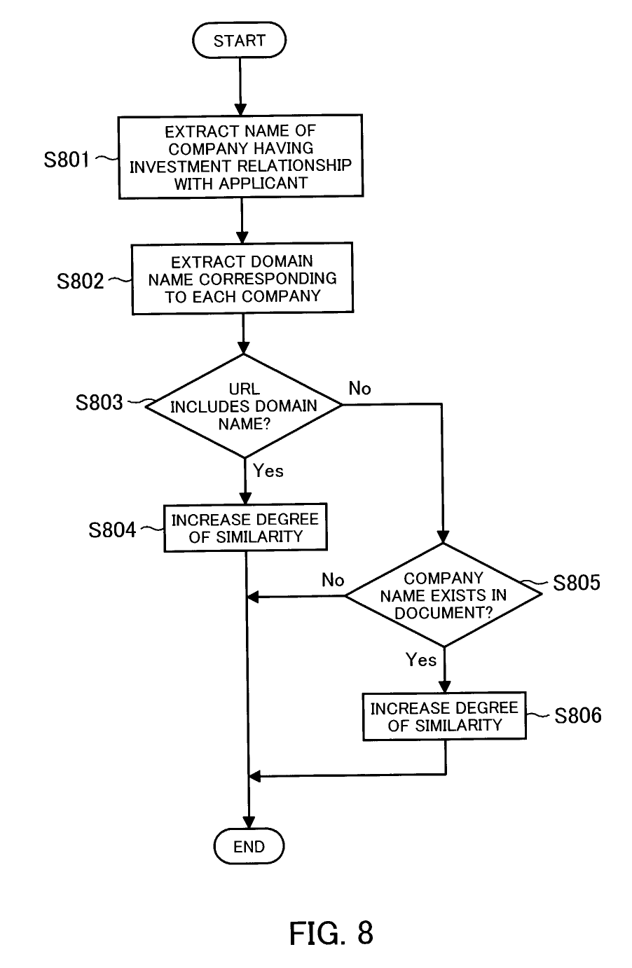

FIG. 8 is a flowchart of a sequence of similarity correction processing using the investment-relationship database 133 and the company-domain correspondence database 134.

In step S801, a name or names of a company or companies which have an investment relationship with a company as the applicant of an unexamined patent publication are extracted by a search, by referring to the investment-relationship DB 133 based on the company name of the applicant. In step S802, domain names corresponding to the name or names of the company or companies extracted in step S801 and the company name of the applicant are extracted by referring to the company-domain correspondence DB 134.

In step S803, it is determined whether or not the URL of a document extracted by a search of the network-document DB 100b includes one of the above domain names extracted in step S802. When yes is determined in step S803, the operation goes to step S804. Since, in this case, the document extracted by the search of the network-document DB 100b is published in an official web site of the extracted company or one of the extracted companies, or a web site in which the extracted company or one of the extracted companies provides a service, the document extracted by the search of the network-document DB 100b is highly relevant. Therefore, in step S804, the degree of similarity for the document is increased, and the processing of FIG. 8 is completed. At this time, the degree of similarity is particularly increased when the URL of the document includes the domain name corresponding to the company as the applicant.

On the other hand, when it is determined in step S803 that the URL of the above document does not include one of the above domain names extracted in step S802, the operation goes to step S805, and it is determined whether or not at least one of the name or names of the company or companies extracted in step S801 and the company name of the applicant is included in the document extracted by the search of the network-document DB 100b. When yes is determined in step S805, it is likely that this document is related to the company as the applicant. Therefore, the degree of similarity is increased in step S806, and then the processing of FIG. 8 is completed. When no is determined in step S805, the processing of FIG. 8 is completed without performing no further operation.

As explained above, when the degree of similarity is corrected by using the investment-relationship DB 133 and the company-domain correspondence DB 134, it is possible to analyze relevance between a business-model patent and a document published on the Internet 10 by a company related to the company as the applicant of the patent as well as relevance between the patent and a document published by the company as the applicant, without omission.

Since, according to the correction by using the first to third types of information, the degree of similarity is corrected based on information specific to the business-model-patent field, the accuracy of the degree of similarity can be efficiently increased. In particular, when the documents stored in the patent DB 100a and the network-document DB 100b are described in XML or the like, and items, bibliographic information, or the like is indicated by tagging, and tags to be analyzed and a correction rule corresponding to obtained information are predefined, it is possible to universally construct a processing means for correcting a degree of similarity as described above.

Next, processing in the search-result processing unit 140 and the workflow processing unit 150 is explained.

When the search-result processing unit 140 receives from the network-document-search processing unit 130 all of at least one document corresponding to an unexamined patent publication output from the patent-search processing unit 120 and at least one degree of similarity, the search-result processing unit 140 temporarily registers a list of the at least one document and the at least one degree of similarity in the search-result DB 141, and outputs the search result and the at least one degree of similarity to the workflow processing unit 150.

The workflow processing unit 150 receives the search result and the at least one degree of similarity, and sends the search result and the at least one degree of similarity to the evaluator terminal 200 by email or instant messaging as a notification to an evaluator. Generally, more than one evaluator and more than one evaluator terminal 200 exist. In this case, it is possible to selectively determine an evaluator as a destination of the notification according to the field of the documents in the search result (based on the IPC code in the unexamined patent publication extracted by the search, the company name in the documents, or the like).

The evaluator views the notified data, examines the contents of the documents as the search result or the like based on knowledge of the evaluator, and returns to the document-search server 100 a comment on the search result or the like. For example, the comment indicates how the unexamined patent publication extracted by the search is related to the at least one document similar to the unexamined patent publication. In addition, when the evaluator finds by the examination an obvious error in the calculation of the degree of similarity or the like, the evaluator notifies the document-search server 100 of the error.

The workflow processing unit 150 sends the returned information to the search-result processing unit 140. The search-result processing unit 140 attaches information to a corresponding search result and degree of similarity in the search-result DB 141 based on the returned information, and updates the registered information. In addition, the search-result processing unit 140 correct or delete a search result which contains an obvious error. Further, the search-result processing unit 140 outputs to the output-screen processing unit 111 the search result and degree of similarity of which an evaluation has been obtained. When the above processing is performed, the documents and the degree of similarity output from the network-document-search processing unit 130 can be checked by the evaluator before being sent to a user, and therefore the accuracy of the search result can be increased.

In addition, since it takes a substantial time for the evaluator to make the above check, the search-result processing unit 140 may set a time limit on reception of the return from the workflow processing unit 150, and output the search result and the degree of similarity to the output-screen processing unit 111 when the time limit expires.

Further, although the search result and the degree of similarity are confirmed in the above workflow, it is possible to register persons who are interested in business-model patents, and send the search result and the degree of similarity to the registered persons. For example, when a patent publication of a competitor of a certain company in a business is obtained by a search, the search result is sent to a person in charge in the company for warning. The person in charge returns to the document-search server information indicating whether or not the search result affects the business of the company. Thus, it is possible to recognize whether or not the search result is useful in the actual business, and use the returned information for improving the search processing system.

When the output-screen processing unit 111 receives the search result and the degree of similarity from the search-result processing unit 140, the output-screen processing unit 111 produces image data for notifying an applicable user about the search result and the degree of similarity, based on the received information, and sends the image data to an applicable one of the plurality of terminals 21, 22, and 23.

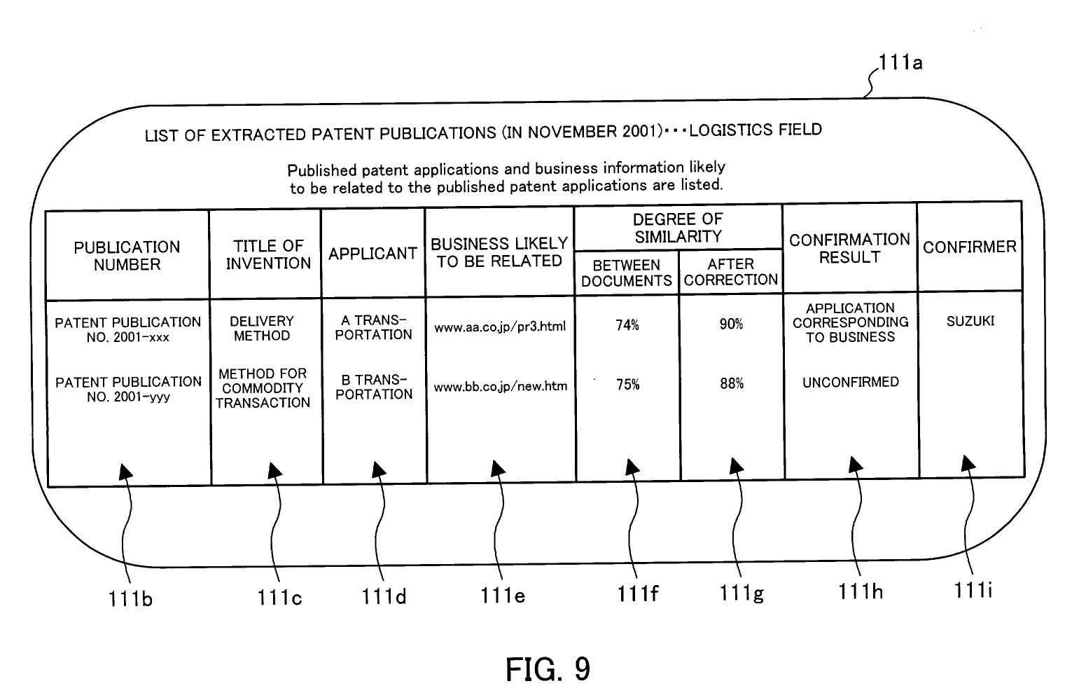

FIG. 9 is a diagram illustrating an example of display of a screen for notifying a terminal user about a search result.

As illustrated in FIG. 9, in the notification screen 111a, items including unexamined patent publication numbers 111b, corresponding titles of inventions 111c, corresponding applicants 111d, and URLs 111e of similar documents obtained by searches of the network-document DB 100b corresponding to the unexamined patent publication numbers 111b are indicated, where the URLs 111e of similar documents are indicated as “business likely to be relevant.” A plurality of combinations of the corresponding items are displayed in decreasing order of the degree of similarity after the correction in such a manner as to be read at a glance. Thus, it is possible to easily recognize a plurality of combinations of highly related documents. In each combination, both of a degree of similarity 111f between documents obtained by searches based on only document structures and a corrected degree of similarity 111g are indicated. In addition, for each combination confirmed by an evaluator, a comment (confirmation result 111h) by the evaluator and a name of a confirmer 111i are indicated.

In the above document-search server 100, at least one document on the Internet 10 similar to a business-model patent publication obtained by a search of the patent DB 110a is extracted by a search of the network-document DB 100b. At this time, in the network-document-search processing unit 130, the degree of similarity between document structures is calculated, and the degree of similarity is corrected based on the information specific to the business-model-patent field. Therefore, the accuracy of the degree of similarity can be increased. Thus, it is possible to provide information on an actual business corresponding to a business-model patent application with high accuracy and efficiency.

Although, in the above embodiment, the processing for searching documents is performed and notification is made every time a search query is input, it is possible to perform search processing at regular time intervals in accordance with a search condition which is preset, and make a notification of a search result in accordance with a workflow. In this case, for example, a user preliminarily registers at least one keyword relating to the business-model patent in the document-search server 100 by using an input screen in a web site or the like.

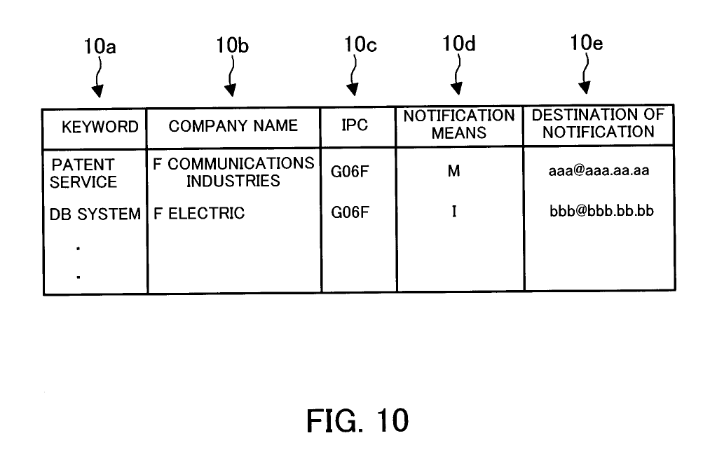

FIG. 10 is a diagram illustrating an example of information preliminarily registered in the document-search server 100.

By the preliminary registration, the document-search server 100 holds information including a keyword 10a, a company name 10b, an IPC 10c, a notification means 10d, a destination of notification 10e, and the like, as illustrated in FIG. 10. In the column for the notification means 10d in FIG. 10, email is denoted by M, and instant messaging is denoted by I.

The patent-search processing unit 120 searches the patent DB 100a at regular time intervals in accordance with a search condition indicating, for example, a field of a patent. In the example of information registration illustrated in FIG. 10, the search condition may be designated by the IPC 10c. The regular search may be managed by the workflow processing unit 150.

The workflow processing unit 150 monitors a search result and a degree of similarity corresponding to the regular search. In addition, when a word or phrase which is registered in the column of the keyword 10a in FIG. 10 is extracted by scanning of a document obtained by the search of the network-document DB 100b, the workflow processing unit 150 sends a search result and a degree of similarity in accordance with designation of the notification means 10d and the destination of notification 10e.

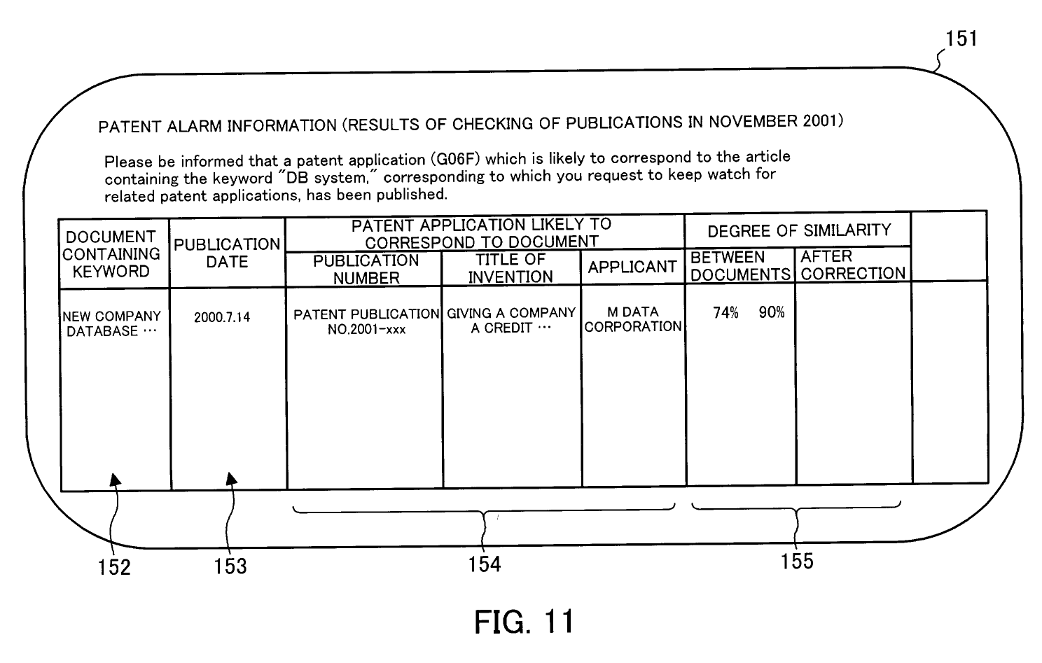

FIG. 11 is a diagram illustrating an example of display of a document attached to an email transmitted to a registrant.

When a search result and a degree of similarity are sent from the workflow processing unit 150 by email, a document file 151 as illustrated in FIG. 11 is attached to the email. As illustrated in FIG. 11, a document 152 containing the registered keyword 10a, a publication date of the document 152, and information 154 on an unexamined patent publication corresponding to the document 152 obtained by a search of the patent DB 100a are displayed as the search result in the document 151. In addition, degrees of similarity 155 between the documents before and after the correction are displayed. Further, when a plurality of combinations of documents are obtained by the search, the plurality of combinations are displayed in decreasing order of the degree of similarity after the correction.

According to the above arrangement, when a document containing a keyword 10a is obtained by a search of the network-document DB 100b for a certain business field, a user which has registered the keyword 10a can acquire the document and an unexamined patent publication which is likely to correspond to the document. Since the search of the patent DB 100a is made at regular time intervals, the unexamined patent publications can be searched without omission. Therefore, it is possible to efficiently acquire at least one document belonging to a desired business field and being published on the Internet 10 and patent information highly related to the document.

Further, when publications of registered patents are stored in the patent DB 100a in the document-search server 100, it is possible to provide a service for searching for a document used for an opposition against a registered (granted) patent. This service can be realized by changing the conditions in the document formatting and the correction of the degree of similarity.

First, for example, a condition for extracting a patent to which an opposition is to be filed is designated as a search condition which is input into the patent-search processing unit 120. Specifically, for example, the field of the patent is designated by an applicant, an IPC, and the like, and a period is designated so that all of the patents registered in the period are searched.

The network-document-search processing unit 130 formats a document obtained by a search of the patent DB 100a. At this time, the descriptions in the items “means for solving the problem” and the like, which are removed in the above embodiment, are left as an object of the search.

Subsequently, the network-document DB 100b is searched for a document having similar contents, and a degree of similarity is calculated and corrected. In this correction, attention is focused on whether or not the document obtained by the search of the network-document DB 100b is published before the filing date of the corresponding patent.

Specifically, when the publication date of the document obtained by the search precedes the filing date of the corresponding patent, the degree of similarity is increased. In addition, when the document is published by the applicant of the corresponding patent, the degree of similarity is further increased. Thus, it is possible to find a case where the contents of a patent is unintentionally disclosed before filing the application for the patent.

Further, for example, when a news article or the like is obtained by the search, and a name, acronym, or the like of the applicant is included in the news article, the degree of similarity is increased. However, the degree of similarity is not increased when the article is indicated as an exception to loss of novelty in the corresponding patent publication.

In the above service, the value of the degree of similarity which is output indicates how similar the patent publication obtained by the search and the document obtained from the Internet 10 are. In addition, it is possible to consider that the value of the degree of similarity indicates a degree of effectiveness in filing the opposition. Since the document-search server 100 can output such a degree of similarity with high accuracy and efficiency, it is possible to provide a service which is effective in patent practice.

In addition, in the above service, the workflow processing unit 150 can also send the search result and the degree of similarity to an evaluator, receive an evaluation indicating whether or not the search result and the degree of similarity can be actually used in the opposition, and reflect the evaluation result on information which is sent to a user.

Next, the second embodiment of the present invention is explained. In the second embodiment, a delivery server for providing newspaper articles to users is provided. The delivery server comprises a processing means for sending to users information on (i.e., notifying users about) a patent publication corresponding to an arbitrary newspaper article related to a business-model patent. The basic functions of this processing means are similar to the aforementioned processing means which the document-search server 100 comprises.

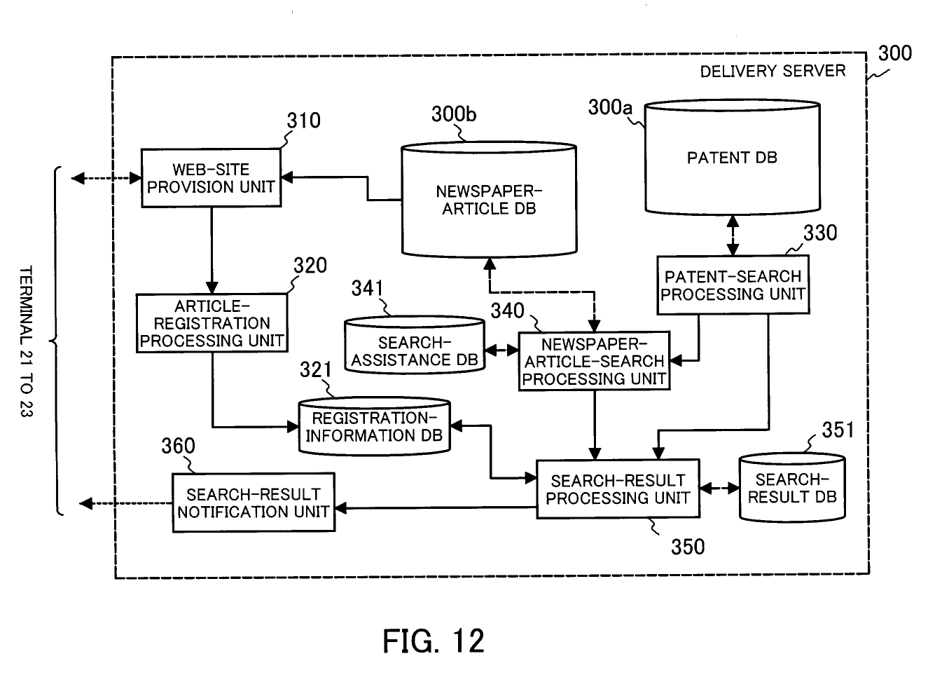

FIG. 12 is a block diagram illustrating the functions of the delivery server.

In the following explanations, correspondences with the functions of the document-search server 100 illustrated in FIG. 4 are indicated when necessary.

The delivery server 300 in FIG. 12 is assumed to be connected to the terminals 21 to 23 through the Internet 10. The delivery server 300 comprises a web-site provision unit 310, an article-registration processing unit 320, a patent-search processing unit 330, a newspaper-article-search processing unit 340, a search-result processing unit 350, and a search-result notification unit 360. In addition, the delivery server 300 comprises a patent DB 300a, a newspaper-article DB 300b, a registration-information DB 321, a search-assistance DB 341, and a search-result DB 351.

The patent DB 300a stores unexamined patent publications one by one when the unexamined patent publications are published, in a similar manner to the patent DB 100a in the document-search server 100. The newspaper-article DB 300b stores newspaper articles to be delivered to users. The newspaper-article DB 300b may collect newspaper-article information published on the Internet 10, and store the newspaper-article information one item by one item.

The web-site provision unit 310 extracts newspaper articles from the newspaper-article DB 300b, and delivers the extracted newspaper articles to the users through web pages. In addition, when the web-site provision unit 310 receives a notification request for information on a patent publication corresponding to a delivered newspaper article, the web-site provision unit 310 sends the notification request to the article-registration processing unit 320 together with registration information.

The article-registration processing unit 320 registers designated newspaper articles and registration information on corresponding users in the registration-information DB 321 based on information from the web-site provision unit 310. The registration-information DB 321 stores names of users, addresses (e.g., email addresses) of destinations of notifications, file names or URLs of the designated newspaper articles, and the like.

The patent-search processing unit 330 searches the patent DB 300a at regular time intervals, extracts an unexamined patent publication which is newly registered in the patent DB 300a, and outputs the extracted unexamined patent publication to the newspaper-article-search processing unit 340 and the search-result processing unit 350.

The newspaper-article-search processing unit 340 has similar processing functions to the network-document-search processing unit 130 in the document-search server 100. That is, the newspaper-article-search processing unit 340 searches the newspaper-article DB 300b for a newspaper article having contents similar to the contents of the extracted unexamined patent publication, and calculates a degree of similarity between the newspaper article and the unexamined patent publication. In addition, the search-assistance DB 341 holds information similar to the information held by the search-assistance DB 131 in the document-search server 100, and is referred to when the newspaper-article-search processing unit 340 performs processing.

The search-result processing unit 350 receives documents as search results of the patent-search processing unit 330 and the newspaper-article-search processing unit 340 and a degree of similarity, and stores the received documents and degree of similarity in the search-result DB 351. In addition, the search-result processing unit 350 refers to the registration-information DB 321, and outputs the search result and the degree of similarity to the search-result notification unit 360 when the file name or URL of the newspaper article obtained by the search coincides with a file name or URL registered in the registration-information DB 321 and the calculated degree of similarity equal to or greater than a predetermined value.

The search-result notification unit 360 sends the information (including the search result and the degree of similarity) output from the search-result processing unit 350 to an applicable user by email or instant messaging.

The processing in the delivery server 300 is explained below.

The delivery server 300 provides a first service (newspaper-article delivery service) for supplying the newspaper articles stored in the newspaper-article DB 300b to users, and a second service (notification service) for designating a newspaper article in the newspaper-article DB 300b, searching the patent DB 300a at regular time intervals, and sending information on a patent publication to a user (i.e., notifying a user about a patent publication) when a patent related to the designated newspaper article is published. The main purpose of the second service is to monitor for publication of a patent corresponding to a designated newspaper article.

In the newspaper-article delivery service, a user accesses a web site of the delivery server 300, and the delivery server 300 provides newspaper articles in the web site, for example, after password checking or the like. In the processing for this service, a screen for inquiring of a user whether or not the user requests transmission of information on (notification about) a published patent related to a newspaper article about a new business is displayed when the newspaper article is delivered.

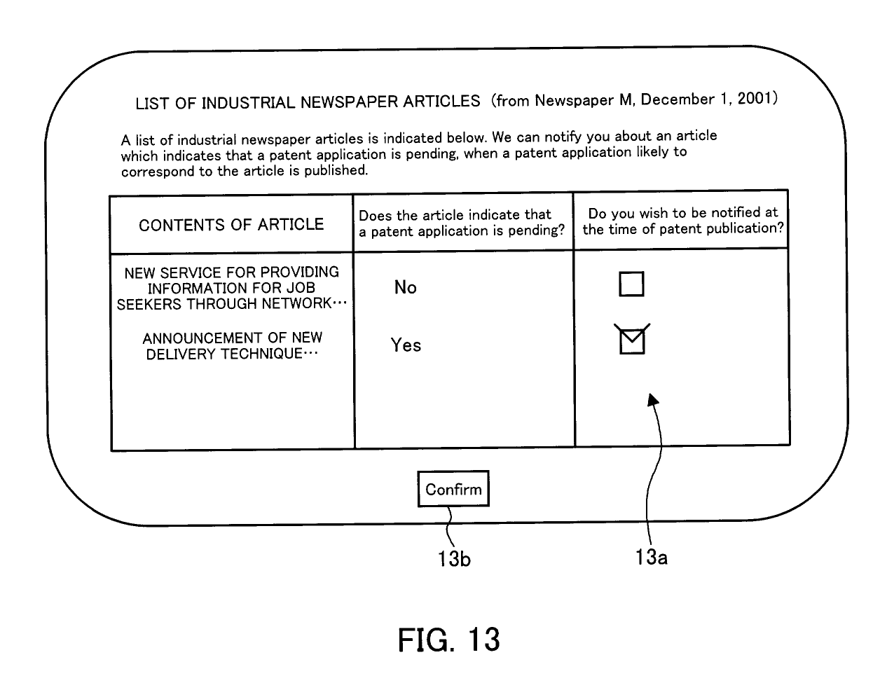

FIG. 13 is a diagram illustrating an example of display of a screen for requesting transmission of information on a patent. The screen of FIG. 13 indicates a list of the contents of delivered newspaper articles and information indicating whether or not each of the delivered newspaper articles refers to existence of a pending patent application. In addition, when information on a patent related to contents of a newspaper article is published, an input area 13a for requesting transmission of the information on the patent (i.e., notification about the patent) and a confirm button 13b for confirming the input are displayed.

Since information indicating whether or not each of the delivered newspaper articles refers to existence of a pending patent application is displayed, the user can recognize the existence of a corresponding patent application based on the displayed information. When the user requests transmission of information (notification) at the time of publication of the patent, the user checks the input area 13a and clicks the confirm button 13b. Thus, a request for transmission of information (i.e., notification request) is transmitted to the delivery server 300. Alternatively, the delivery server 300 may be arranged to display a checkbox in the input area 13a only when the corresponding document includes a description such as “patent pending.”

When the web-site provision unit 310 receives the request for transmission of information on a patent publication (i.e., the notification request), the web-site provision unit 310 outputs to the article-registration processing unit 320 information including a file name of a newspaper article as a search reference, a name of the user who inputs the notification request, an address of a destination of notification, a desired means for notification, and the like.

The information on the user among the above information can be automatically produced based on registration information in the newspaper-article delivery service. In addition, it is possible to provide a screen for selecting a desired means (e.g., email or instant messaging) for notification and receiving input from the user.

The article-registration processing unit 320 registers the received information in the registration-information DB 321 as registration information for the notification service. Thus, the registration processing in the service for sending information on (notifying about) a patent publication is completed.

Next, processing which is performed when the notification service is in operation is explained.

When the correspondence between the patent DB 300a in the delivery server 300 and the patent DB 100a in the document-search server 100 and the correspondence between the newspaper-article DB 300b in the delivery server 300 and the network-document DB 100b in the document-search server 100 are considered, the processing flow for searching the patent DB 300a and the newspaper-article DB 300b and calculating the degree of similarity in the delivery server 300 is basically the same as the processing flow for searching the patent DB 100a and the network-document DB 100b and calculating the degree of similarity in the document-search server 100.

First, the patent-search processing unit 330 regularly searches for an unexamined patent publication which is newly registered in the patent DB 300a. For example, the patent-search processing unit 330 monthly makes a search under a search condition that the publication date belongs to a preceding month. In addition, the field of the patent may be designated by the IPC or the like. The unexamined patent publications obtained by the search are output one by one to the newspaper-article-search processing unit 340 and the search-result processing unit 350.

Since the processing in the newspaper-article-search processing unit 340 is identical to the processing in the network-document-search processing unit 130 in the document-search server 100 except for a portion of the correction condition in the correction of the degree of similarity, the processing in the newspaper-article-search processing unit 340 is briefly explained.

First, the newspaper-article-search processing unit 340 formats the document of the received unexamined patent publication so as to be adapted for the search of the newspaper-article DB 300b. At this time, a patent-term dictionary (not shown) in the search-assistance DB 341 is referred to when necessary. Then, the newspaper-article DB 300b is searched for a newspaper article having contents similar to the contents of the formatted document, and a degree of similarity is calculated.

Next, the calculated degree of similarity is corrected. In the correction processing, an investment-relationship DB (not shown) and a company-domain correspondence DB (not shown) in the search-assistance DB 341 are referred to when necessary. However, the correction based on a URL related to a company indicated as an applicant in the unexamined patent publication is made only when the newspaper article obtained by the search of the newspaper-article DB 300b is a newspaper article collected from the Internet 10. When this correction processing is performed, the value of the degree of similarity becomes a highly accurate value on which the characteristics of the business-model patent are reflected. The corrected degree of similarity is output to the search-result processing unit 350 as well as the newspaper article obtained by the search.

The search-result processing unit 350 temporarily stores in the search-result DB 351 the received unexamined patent publication as well as the newspaper article and the degree of similarity corresponding to the unexamined patent publication. Then, the following processing is performed.

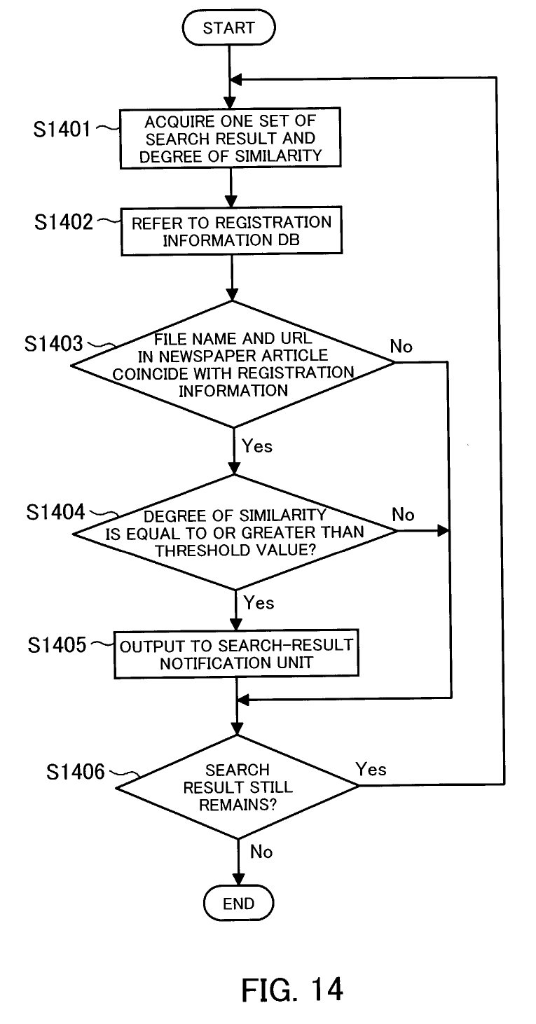

FIG. 14 is a flowchart of a sequence of processing in the search-result processing unit 350.

In step S1401, a set of a search result (including an unexamined patent publication and at least one corresponding newspaper article) and a degree of similarity is acquired from the search-result DB 351, where the search result includes an unexamined patent publication and a newspaper article. In step S1402, the registration-information DB 321 is referred to, and registration information is acquired.

In step S1403, it is determined whether or not a file name and a URL in a newspaper article indicated in the registration information coincide with those of the newspaper article obtained by the search. When yes is determined in step S1403, the operation goes to step S1404. When no is determined in step S1403, the operation goes to step S1406.

In step S1404, it is determined whether or not the value of the degree of similarity is equal to or greater than a predetermined threshold value. When yes is determined in step S1404, the operation goes to step S1405. When no is determined in step S1404, the operation goes to step S1406.

In step S1405, a newspaper article designated by a user and a corresponding unexamined patent publication are extracted. Since it is determined that the degree of similarity is equal to or greater than the predetermined threshold value, these data are output to the search-result notification unit 360. At this time, applicable registration information is also output.

In step S1406, it is determined whether or not a search result still remains in the search-result DB 351. When yes is determined in step S1406, the operation goes to step S1401, and the processing in steps S1401 to S1405 is repeated for a next set of a search result and a degree of similarity. When no is determined in step S1406, the processing of FIG. 14 is completed.

When the data are output to the search-result notification unit 360 by the processing in step S1405, the search-result notification unit 360 produces a document for notification to the user based on the received data, attaches a file of the document to an email or instant message, and transmits the email or instant message to the user.

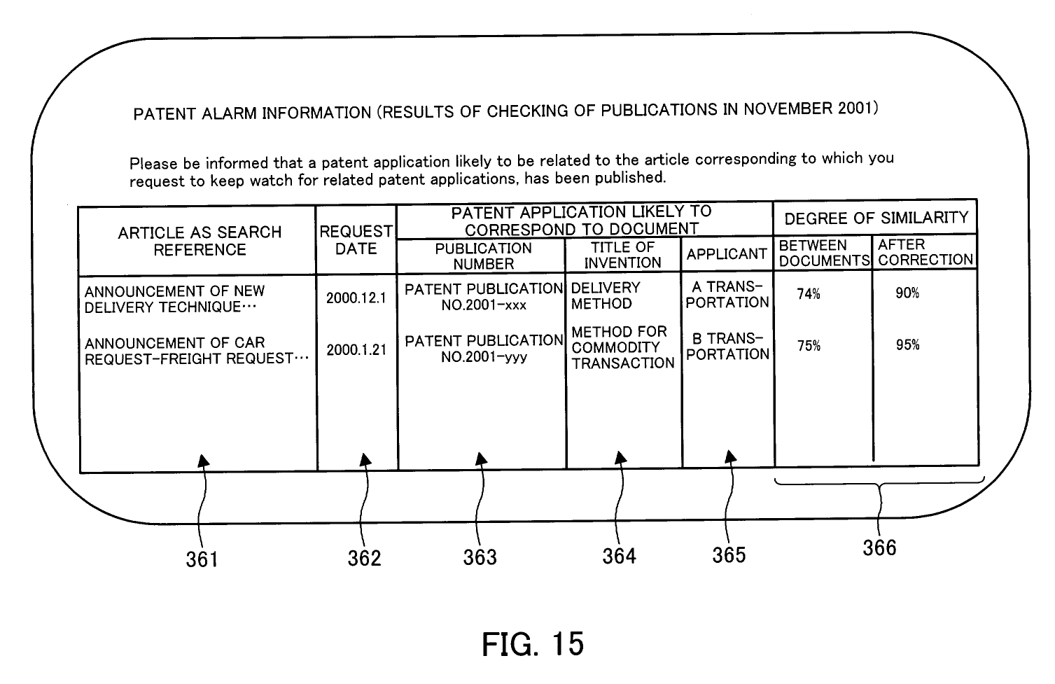

FIG. 15 is a diagram illustrating an example of display of a document attached to an email to a user.

As illustrated in FIG. 15, an at-a-glance table is provided to the user. In the at-a-glance table, a request date 362 for the notification service, an unexamined patent publication number 363 of an unexamined patent publication obtained by a search, a title of invention 364, an applicant 365, and the like are displayed corresponding to a newspaper article 361 which is designated in advance as a search reference. In addition, degrees of similarity 366 to the corresponding unexamined patent publication before and after the correction are displayed. Further, when a plurality of unexamined patent publications corresponding to a newspaper article as a search reference are obtained by the search, the plurality of unexamined patent publications are displayed in decreasing order of the degree of similarity after the correction in such a manner as to be read at a glance.

In the second embodiment, users of the notification service for sending information on a patent publication can automatically receive information on a patent corresponding to a newspaper article in the newspaper-article DB 300b designated in advance, when the patent is published. At this time, a degree of similarity between the designated newspaper article and the unexamined patent publication is corrected based on information specific to the business-model patent field. Therefore, it is possible to receive a service with high accuracy.

It is possible to further provide a workflow processing unit in the delivery server 300. The workflow processing unit execute a workflow associated with reception of a search result by the search-result processing unit 350. This workflow processing unit has functions equivalent to the functions of the workflow processing unit 150 provided in the document-search server 100. For example, the workflow processing unit in the delivery server 300 sends a search result and a degree of similarity from the search-result processing unit 350 to a terminal used by an evaluator by using a push-type notification means such as email, and receives an evaluation result. The received evaluation result is output to the search-result processing unit 350. The search-result processing unit 350 updates corresponding information (a list of a newspaper article, at least one unexamined patent publication corresponding to the newspaper article, and at least one degree of similarity between the newspaper article and the at least one unexamined patent publication) in the search-result DB 351 by using the evaluation result. In addition, the delivery server 300 may be arranged to reflect the evaluation result on information which is to be sent to a user through the search-result notification unit 360.

Further, the delivery server 300 may be arranged to enable provision of a document-search service similar to the aforementioned service provided by the document-search server 100, as well as the notification service for sending information on a patent publication corresponding to a designated newspaper article. In this case, the processing functions for searching the two databases, calculating a degree of similarity, and making a correction can be commonly used by the above two services.

For example, when a user of the document-search service is denoted as a first user, and a user of the notification service for sending information on a patent publication is denoted as a second user, the patent DB 300a is searched according to input of a search query by the first user, the newspaper-article DB 300b is searched for at least one newspaper article having contents similar to the contents of an unexamined patent publication obtained by the search of the patent DB 300a, and at least one degree of similarity between the at least one newspaper article and the unexamined patent publication is output. Thus, a list of the unexamined patent publication, the at least one similar newspaper article, and the at least one degree of similarity is provided to the first user.

On the other hand, the second user designates an arbitrary newspaper article in the newspaper-article DB 300b as a search reference, and the newspaper-article DB 300b is regularly searched for a similar document to an unexamined patent publication which is newly registered in the patent DB 300a. Then, the designated newspaper article is obtained by a search, and an unexamined patent publication corresponding to the designated newspaper article and a degree of similarity are sent to the second user when the degree of similarity is equal to or greater than a predetermined value. Alternatively, notification to the second user may be made when a designated newspaper article is obtained by providing the document-search service for a number of first users, and the degree of similarity is equal to or greater than a predetermined value.

In the above cases, each of the degrees of similarity provided by the document-search service and the notification service is obtained by calculating a degree of similarity based on document structures of the documents obtained by the searches, and then correcting the degree of similarity based on information specific to the business-model-patent field. Therefore, the delivery server 300 can provide both of the document-search service and the notification service with high accuracy by using the common processing functions. Thus, the delivery server 300 becomes very useful.

The above processing functions can be realized by a server computer in a client-server system. In this case, a server program which describes details of processing realizing the functions which the document-search server 100 or the delivery server 300 should have. The server computer executes the server program in response to a request from a client computer. Thus, the above processing functions can be realized on the server computer, and a processing result is supplied to the client computer.

The server program describing the details of processing can be stored in a recording medium which is readable by the server computer. The recording medium may be a magnetic recording device, an optical disk, an optical magnetic recording medium, a semiconductor memory, or the like. The magnetic recording device may be a hard disk drive (HDD), a flexible disk (FD), a magnetic tape, or the like. The optical disk may be a DVD (Digital Versatile Disk), a DVD-RAM (Random Access Memory), a CD-ROM (Compact Disk Read Only Memory), a CD-R (Recordable)/RW (ReWritable), or the like. The optical magnetic recording medium may be an MO (Magneto-Optical Disk) or the like.

In order to put the server program into the market, for example, it is possible to sell a portable recording medium such as a DVD or a CD-ROM in which the server program is recorded.

The server computer which executes the server program stores the server program in a storage device belonging to the server computer, where the server program is originally recorded in, for example, a portable recording medium. The server computer reads the server program from the storage device, and performs processing in accordance with the server program. Alternatively, the server computer may directly read the server program from the portable recording medium for performing processing in accordance with the server program.

As explained above, in the document search method according to the present invention, the second document information having contents similar to the contents of the first document information, which is acquired from the network and formatted, is obtained by a search of the document database, and a degree of similarity between the formatted first document information and the second document information obtained by the search is calculated. In addition, the degree of similarity is corrected in accordance with a condition which is preset. Therefore, it is possible to efficiently obtain the second document information having the contents similar to the contents of the first document by the search of the document database, and increase the accuracy in the calculation of the degree of similarity between the first and second documents.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A document search method executed by a computer for extracting from a document database document information similar to other document information which is acquired from a network, comprising the steps of:
(a) formatting first document information acquired from the network into a format of the document database; and
(b) outputting second document information and similarity information, where the second document information exists in the document database and is similar to the formatted first document information, and the similarity information is obtained by correcting a degree of similarity between the formatted first document information and the second document information in accordance with a condition which is preset.

2. The document search method according to claim 1, wherein the formatted first document contains first time information related to time, the second document contains second time information related to time, and said degree of similarity is increased for correcting the degree of similarity when each of the first time information and the second time information indicates a time within a predetermined period.

3. The document search method according to claim 1, wherein said computer is able to refer to a company database which indicates relationships between companies, and said degree of similarity is increased for correcting the degree of similarity when the computer refers to the company database, and determines that company information included in the formatted first document information is related to company information included in the second document information.

4. The document search method according to claim 3, wherein said company database belongs to said computer.

5. The document search method according to claim 1, wherein said first document information is patent document information.

6. The document search method according to claim 1, wherein said document database stores document information extracted from said network.

7. A document search method executed by a computer for extracting from a network document information similar to other document information which is extracted from a document database, comprising the steps of:
(a) searching said document database based on a search query which is input by a user, so as to extract first document information;
(b) formatting said first document information extracted in step (a) into a predetermined format; and
(c) outputting second document information and similarity information, where the second document information is extracted from said network and is similar to the formatted first document information, and the similarity information is obtained by correcting a degree of similarity between the formatted first document information and the second document information in accordance with a condition of correction which is preset.

8. The document search method according to claim 7, wherein the formatted first document contains first time information related to time, the second document contains second time information related to time, and said degree of similarity is increased for correcting the degree of similarity when each of the first time information and the second time information indicates a time within a predetermined period.

9. The document search method according to claim 7, wherein said computer is able to refer to a company database which indicates relationships between companies, and said degree of similarity is increased for correcting the degree of similarity when the computer refers to the company database, and determines that company information included in the formatted first document information is related to company information included in the second document information.

10. The document search method according to claim 9, wherein said company database belongs to said computer.

11. The document search method according to claim 7, wherein said first document information is patent document information.

12. A document search method executed by a computer for extracting from first and second document databases first document information and second document information which are similar in content, comprising the steps of:
(a) searching said first document database based on a search query which is input by a user, so as to extract said first document information;
(b) formatting said first document information extracted in step (a) into a format of said second document database; and
(c) outputting said second document information and similarity information, where the second document information is extracted from the second document database and is similar in content to the formatted first document information, and the similarity information is obtained by correcting a degree of similarity between the formatted first document information and the second document information in accordance with a condition which is preset.

13. A document search program which makes a computer perform document search processing for extracting from first and second document databases first document information and second document information which are similar in content, said document search processing comprising the steps of:
(a) searching said first document database based on a search query which is input by a user, so as to extract said first document information;
(b) formatting said first document information extracted in step (a) into a format of said second document database; and
(c) outputting said second document information and information on similarity between the formatted first document information and the second document information, where the second document information is extracted from the second document database and is similar in content to the formatted first document information.

14. The document search program according to claim 13, wherein said information on similarity is obtained by correcting a degree of similarity between the formatted first document information and the second document information in accordance with a condition which is preset, after calculation of the degree of similarity.

15. A document search method executed by a computer for extracting document information similar in content from first and second document databases, comprising the steps of:
(a) preliminarily registering first document information of which a user is to be notified, in said first document database;
(b) searching for document information newly stored in said second document database, at regular time intervals, so as to extract second document information;
(c) formatting said second document information extracted in step (b) into a format of said first document database;
(d) searching said first document database by using the formatted second document information, outputting third document information which is similar in content to said formatted second document information, and calculating a degree of similarity between the formatted second document information and the third document information;
(e) correcting said degree of similarity in accordance with a condition which is preset; and
(f) sending said second document information extracted from said second document database and the corrected degree of similarity to said user when said third document information is said first document information, and the corrected degree of similarity is equal to or greater than a predetermined value.

16. A document search apparatus for extracting first document information and second document information similar in content from first and second document databases, comprising:
first document search means for searching said first document database based on a search query which is input by a user, so as to extract said first document information;
document formatting means for formatting said first document information extracted from said first document database, into a format of said second document database;
second document search means for searching said second document database by using the formatted first document information, outputting said second document information which is similar in content to the formatted first document information, and calculating a degree of similarity between the formatted first document information and the second document information;
correction means for correcting said degree of similarity in accordance with a condition which is preset; and
document output means for outputting said first and second document information and the corrected degree of similarity.
